(19) United States
(12) Patent Application Publication
(10) Pub. No.: US 2003/0146045 A1
(43) Pub. Date: Aug. 7, 2003

(54) Rescue system

(76) Inventor: Frank B. Porter JR., Cambridge, MA (US)

Correspondence Address: Sam Pasternack, Esq., Choate, Hall & Stewart, 53 State Street, Exchange Place, Boston, MA, 02109, US

(21) Appl. No.: 10/068,440

(22) Filed: Feb. 5, 2002

(51) Int. Cl. A62B 1/06

(52) U.S. Cl. 182/11

(57) ABSTRACT

A propulsion unit is adapted to propel a selected tip element into a structure along with a cable attached to the tip element. The cable is secured with respect to the structure and apparatus is provided that cooperates with the cable to allow at least one person at a time to move along the cable to safety. In a preferred embodiment, the propulsion unit is similar to an artillery piece.

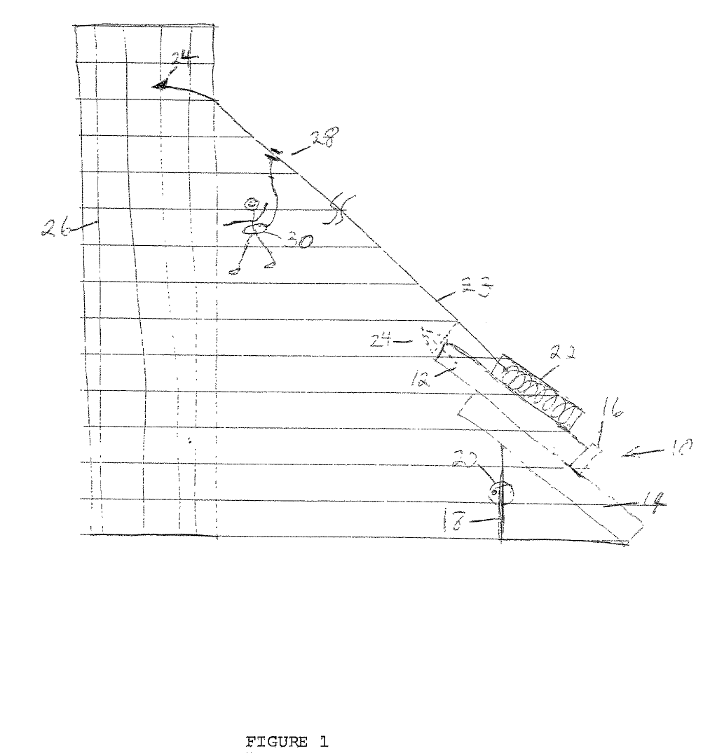

### BACKGROUND OF THE INVENTION

This invention relates to a rescue system and more particularly to a system for propelling a cable into a structure to afford a route of escape.

As the tragic events in New York on Sep. 11, 2001 have shown, people sometimes are trapped in structures at locations high above ground or trapped in situations and locations inaccessible to rescuers. Skyscrapers, for example, typically include stairways in their core for egress during an emergency. If, however, this route of egress is cut off by a catastrophic event and helicopter rescue from the roof is unavailable, building inhabitants above the catastrophic event have no way of leaving the building safely. There is, therefore, a need for a system that will allow a person or groups of persons to exit a building or other structure safely.

### SUMMARY OF THE INVENTION

The rescue system, according to the invention, includes a propulsion unit adapted to propel a selected tip element into a structure along with a cable attached to the tip element. In the context of this invention, the term “structure” shall be construed to include, but is not limited to, buildings, vehicles, bridges, vessels, and natural formations such as cliffs. The cable is securable with respect to the structure. The system also includes apparatus cooperating with the cable to allow at least one person at a time to move along the cable to safety. In a preferred embodiment, the propulsion unit includes a barrel from which the tip element is propelled, for example, by the release of chemical energy such as from gunpowder. A catapult could also be used. The propulsion unit may be mounted for recoil or it may be a recoilless unit.

In this embodiment, the cable is stored in and runs out from a dispenser which may be adjacent to the propulsion unit or located away from the propulsion unit. It is also contemplated that the cable may run out through the barrel itself. The propulsion unit can be operated at selected output power levels depending on range and other circumstances.

The propulsion unit may be located at ground level and transportable on a vehicle or even hand-held. The propulsion unit could also be located in the air or in an adjacent structure. The system further includes apparatus to absorb safely the impact of a descending person or persons.

### BRIEF DESCRIPTION OF THE DRAWING

The single figure of the drawing is a schematic illustration of an embodiment of the present invention.

### DESCRIPTION OF THE PREFERRED EMBODIMENT

With reference to the single figure of the drawing, a propulsion unit 10 includes a barrel 12 supported for movement on a recoil mechanism 14. A breach 16 allows an explosive charge to be loaded into the barrel 12. The recoil mechanism 14 is supported by an arm or arms 18 whose length is adjusted by a cranking mechanism 20 so that the elevation of the barrel 12 may be adjusted.

In this embodiment, a dispenser 22 includes therewithin a suitable length of cable 23 attached to a tip element 24. The propulsion unit 10 is analogous to a harpoon gun, breeches buoy, catapult, or small artillery piece.

It will be appreciated that the propulsion unit may come in different weights which would require a heavier mount to support the barrel 12 and recoil mechanism 14, in which case the arm (or arms) 18 would be replaced by more sophisticated elevating and traversing mechanisms, akin to those employing gears which are found on field artillery pieces.

The operation of the rescue system of the invention will now be described in the context of a rescue from a tall building 26. The propulsion unit 10 is loaded with a charge selected based on the range to the desired location in the building and based on the penetrating power required. For example, if the tip 24 were to be fired through an open window or porthole, a smaller charge can be used. On the other hand, if the tip 24 is required to penetrate a relatively unyielding substance such as thick glass, concrete or masonry, a larger charge is required. The mass and geometry of the tip 24 will also vary depending on the structure that must be penetrated. For example, the tip may need to be made of tool steel to penetrate thick glass, concrete or masonry and have a substantial mass. As those skilled in the art will appreciate, firing tables can be developed based on the range and penetrating power required so that the appropriate charge is selected.

The tip 24 is attached to the cable 23 residing in the dispenser 22. The cable is arrayed within the dispenser 22 so that it may be paid out rapidly. The cable 23 may be any suitable high tensile strength material including steel cable or braided polyethylene rope depending on the application. The cable must have sufficient tensile strength to support at least one, and preferably many, persons at the same time.

In an emergency situation, the propulsion unit 10 is loaded with the appropriate charge as discussed above and the tip 24 (shown in phantom) is inserted into the barrel 12 while connected to the cable 23. The elevation of the propulsion unit 10 is set by adjusting the length of the leg 18 by turning the crank 20.

The persons to be rescued from the building 26 are warned by means of a bullhorn or loud hailer that a projectile will be entering their area so that they can take cover. Thereafter, the propulsion unit 10 is fired propelling the tip 24 and the cable 23 into a desired location within the building 26. Once inside the building 26, the persons to be rescued firmly secure the cable 23 to the building itself or to something inside the building sufficiently strong (supporting beams, piping, or even heavy pieces of furniture or equipment) to bear the weight of those being rescued. Once the invention becomes commercially available, building occupants may designate anchor points in the building for the cable in advance of an emergency. It is contemplated that the tip structure would include one or more safety devices for gripping the cable for use by those awaiting rescue. Various such devices (“descenders”) are already on the market and are often used in mountaineering for descending along a rope in a controllable way.

After the cable 23 is secured to the building, a person to be rescued attaches a descender 28 to the cable 23 and to himself using any one of a number of commercially available harnesses 30 and leaves the building proceeding down the cable 23. A trampoline-like device (not shown) may be provided near the ground to break the fall of the descending individual. In appropriate circumstances, the descending individual could be belayed by someone in the building.

It will be appreciated that in some circumstances it might be necessary to fire a projectile without a cable to breach the structure after which the cable is delivered by a subsequent firing. It will be further appreciated that multiple cables may be required in order to remove everyone. It is preferred that the cable 23 come in standard lengths within the dispenser 22 along with the ability of the rescuers to add or subtract sections depending on the particular task. It will also be appreciated that the propulsion unit 10 could be mounted on a fire engine or rescue vehicle for transport to the scene of a disaster. The system could also be deployed from an adjacent structure, from a vessel or from the air such as from a helicopter. Furthermore, it is contemplated that the system could be easily broken down into its component parts so that it could be moved readily to otherwise inaccessible firing positions.

It is preferred that the rescue system of the invention be operated by highly trained individuals who would engage in regular drills much like canoneers in an artillery unit. It is also contemplated that highly trained rescuers might enter the structure (as by rappelling from a roof or helicopter) after the cable 23 has been delivered to help secure the cable 23 within the structure and to assist those being rescued in leaving the structure 26.

Those skilled in the art will also appreciate that the propulsion unit 10 could be of recoilless design so as to be fired from a light mount or even from the shoulder. It should also be appreciated that after the cable 23 is delivered, the end proximate the propulsion unit 10 may be secured to a location other than that from which the projectile was fired to aid in a safe descent.

It will be appreciated that the invention can be used for a) exiting a structure by using the invention from inside the structure, and b) gaining access to a structure by employing a system of pulleys and an engine. Use of the invention as described in this paragraph might arise in military or quasi-military operations.

It is recognized that modifications and variations of the invention will be apparent to those skilled in the art, and it is intended that all such modifications and variations be included within the scope of the appended claims.

What is claimed is:

1. Rescue system comprising:
a propulsion unit adapted to propel a selected tip element into a structure;
a cable attached to the tip element and securable with respect to the structure; and
means cooperating with the cable for allowing at least one person at a time to move along the cable to safety.

2. The system of claim 1 wherein the propulsion unit includes a barrel from which the tip element is propelled by means of a catapult or by the release of chemical energy.

3. The system of claim 2 wherein the propulsion unit recoils.

4. The system of claim 2 wherein the propulsion unit is recoilless.

5. The system of claim 1 wherein the cable is stored in and runs out from a dispenser.

6. The system of claim 5 wherein the dispenser is adjacent to the propulsion unit.

7. The system of claim 5 wherein the dispenser is located away from the propulsion unit.

8. The system of claim 5 wherein the dispenser is the barrel.

9. The system of claim 1 wherein the propulsion unit can be operated at selected output power levels.

10. The system of claim 1 wherein the propulsion unit may be operated from the ground, from an adjacent structure, from a vessel or from an aircraft.

11. The system of claim 1 wherein the propulsion unit is transportable on a vehicle, vessel, aircraft, or by hand.

12. The system of claim 1 wherein the propulsion unit is hand-held.

13. The system of claim 1 further including means to absorb safely the impact of descending persons.
